(19) United States
(12) Patent Application Publication
(10) Pub. No.: US 2007/0051776 A1
(43) Pub. Date: Mar. 8, 2007

(54) DUAL FRICTION WELDER

(75) Inventors: Stephen R. Estes, South Bend, IN (US); David J. Konieczny, Union Mills, IN (US); Lowell R. Tully, Elkhart, IN (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: SSD CONTROL TECHNOLOGY, INC., South Bend, IN (US)

(21) Appl. No.: 11/428,950

(22) Filed: Jul. 6, 2006

Related U.S. Application Data
(60) Provisional application No. 60/697,070, filed on Jul. 6, 2005.

(51) Int. Cl. A47J 36/02

(52) U.S. Cl. 228/101

(57) ABSTRACT

A friction welding system includes a first spindle and a second spindle. The first spindle and the second spindle securely locate a first part and a second part, respectively. The first spindle defines a first axis. The second spindle defines a second axis. A tailstock fixture is disposed along the first and second axes to securely locate a third part. A motor rotates the first and second spindles. A controller controls the motor and the angular orientation of the first and second spindles. The first spindle is moveable along the first axis. The second spindle is movable along the second axis. The first part and the second part can contact the third pat while rotating to effect two separate fiction welds. The controller controls the rotational position of the first spindle and the second spindle upon completion of the weld.

### CROSS-REFERENCE TO RELATED APPLICATIONS

This application is based on claims the benefit of priority of U.S. Provisional Patent Application Ser. No. 60/697,070, filed Jul. 6, 2005, the entire contents of which are hereby expressly incorporated herein by reference.

### FIELD OF THE INVENTION

The invention relates generally to a friction welder and, more specifically, to a friction welder capable of welding three work-pieces together along two weld interfaces to form a single component.

### BACKGROUND OF THE INVENTION

Friction welding machines are generally known in the art. In a friction weld, heat is generated by rubbing two parts together until the material at the interface between the two work-pieces reaches a plastic state. The two parts are then forged together under pressure to finalize the weld and expel gases, thus forming a single component having an integral bond. A friction weld can typically be formed in a very short period of time compared to more conventional arc welding methods, and thus friction welds are less labor intensive, more uniform and more cost effective than conventional methods. Friction welders are especially well-suited for welding round bars, tubes, or other generally round shapes to one another, or for welding round parts to flat plates, disks, gears, etc. The friction welding process may be used used to produce automotive drive shafts, automotive air bag canisters, gear shafts, engine valves, and other parts, and in other applications in which a high quality weld is desired.

On one known friction welder, a first part or work-piece is mounted to a rotating chuck or spindle assembly, while a second part or work-piece is mounted to a stationary chuck or tailstock. A drive motor accelerates the rotating chuck to a desired speed, and the parts are then forced together under pressure, such that the friction between the two parts produces enough heat to produce a material flux. The parts are then forged together under pressure, which expels gas and produces a fine grain weld.

Some automotive drive shafts are made using the friction welding process. Typically, a first yoke and a second yoke are welded to the opposite ends of a central tube. This process is typically performed in two steps. Ideally, the yolks are located approximately orthogonal to one another. Therefore, after the first yoke has been welded to the central tube, one welding the second yoke to the central tube the orientation of the second yoke relative to the first yoke needs to be controlled. This orientation may be controlled using an orientation system. One such orientation system can be found in U.S. Pat. No. 5,858,142, the entire disclosure of which is incorporated by reference herein and which is assigned to the assignee of the present disclosure.

### BRIEF DESCRIPTION OF THE DRAWINGS

FIG. 1 is a perspective view of a friction welding system assembled in accordance with the teachings of the present invention.

FIG. 1A is an elevational view in schematic of a driveshaft formed from three individual work-pieces using the system of FIG. 1.

FIG. 2 is a fragmentary view and perspective of a support table for supporting the friction welding system of FIG. 1.

FIG. 3 is a cross-sectional taken along line 3-3 of FIG. 2.

FIG. 4 is an enlarged fragmentary view in perspective of a slide table.

FIG. 5 is a cross-sectional view taken along line 5-5 of FIG. 4.

FIGS. 6A-6F are enlarged cross-sectional views in schematic taken at an interface between either one of the rotating work-pieces and the fixed work-piece and illustrating an exemplary weld sequence. FIGS. 6A-6F also illustrate the axial alignment between the rotating work-piece and the fixed work-piece when the weld cycle is complete despite potential axial runout or mis-alignment between the work-pieces experienced during the weld sequence.

FIG. 7 is a schematic illustration of a friction welding control system incorporating the teachings of the present invention.

FIG. 8 is a pow chart of an exemplary main control program used to control the friction welder system illustrated in FIG. 1.

FIG. 9 is a schematic diagram of the amplifier circuit of the control loop shown in FIG. 8.

FIG. 10 is a spindle profile curve in graphic form which indicates the desired spindle speed as a function of time during the entire weld process.

FIG. 11 is an enlarged schematic view of a first work-piece secured in a spindle and another work-piece secured in a center clamp.

### DETAILED DESCRIPTION

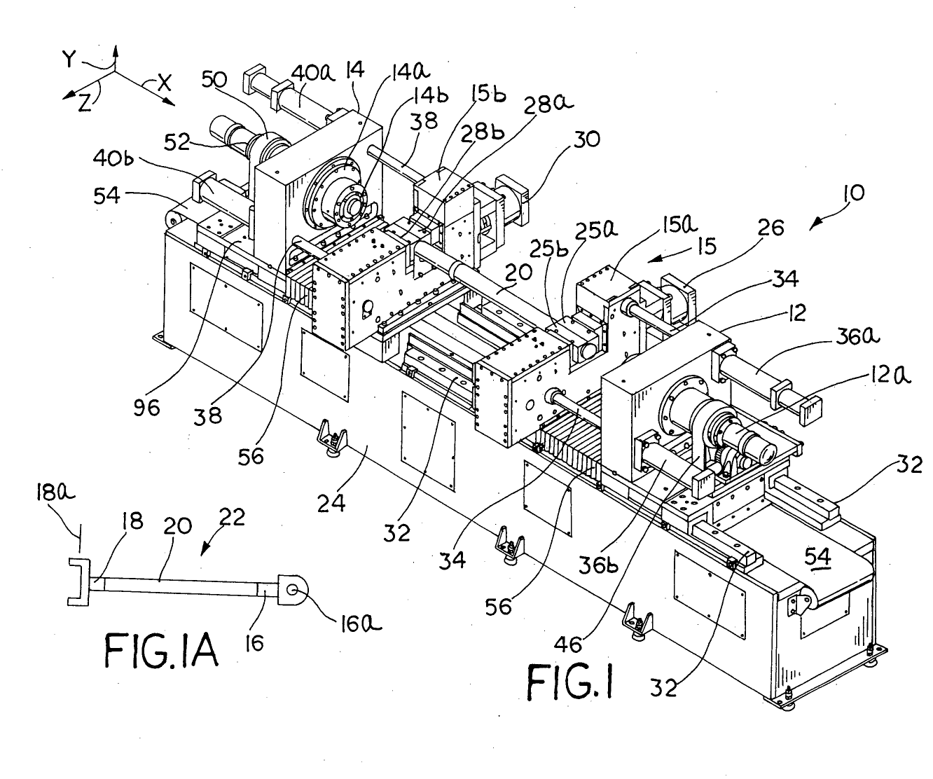

FIG. 1 illustrates an exemplary friction welder 10. The friction welder 10 includes a first spindle assembly 12, a second spindle assembly 14, and a center clamp assembly 15. The first spindle assembly 12 includes a rotatable spindle 12a having a collet 12b (the collet 12b is obscured in FIG. 1 but is similar to collet 14b shown in FIG. 1). The spindle assembly 14 includes a rotatable spindle 14a having a collect 14b. The collets 12b and 14b may be conventional, and are arranged so that the collet 12b secures a first work-piece 16 to the spindle 12a, while the collet 14b secures a second work-piece 18 to the spindle 14a. The first and second work-pieces 16 and 18 are visible in FIG. 1A. The first work-piece 16 includes transverse axis 16a extending into the plane of the Figure, while the second work-piece 18 includes a transverse axis 15a extending vertically in FIG. 1A. The center clamp assembly 15 includes a pair of claps 15a and 15b, which are arranged to secure a third work-piece 20. In the disclosed example, the first and second work-pieces 16 and 18 are yokes of the type commonly employed on drive shafts, while the third work-piece 20 is a shaft or tube. Accordingly, using the disclosed friction welder 10, the first, second and third work-pieces may be assembled to form a drive shaft 22. As will be explained in greater detail below, the orientation of the work-piece 16 relative to the work-piece 18 preferably is controlled such that the orientation of the transverse axis 16a of the work-piece 16 relative to the transverse axis 18a of the work-piece 18 is controlled. It will be understood that, in many applications, these transverse axes 16a, 18a will be oriented orthogonal relative to one another in the finished drive shaft 22. Additionally, as will be described in more detail below, the final positioning of the first and second work-pieces 16, 18 relative to the third work-piece 20 can be accurately controlled during the weld process such as to control the final length of the drive shaft 22 within a predetermined tolerance. The first and second spindle assemblies 12 and 14, along with the individual clamps 15a and 15b of the center clamp assembly 15, are mounted to a table 24.

Referring still to FIG. 1, the clamp 15a includes two individual pieces 25a and 25b. The clamp 15a includes an actuator 26, and the actuator is mounted to the clamp 15a such that, by actuating the actuator 26, the individual pieces 25a and 25b can be separated or brought together as desired in order to release or secure the third work-piece 20 in the clamp 15a. Similarly, the clamp 15b includes a pair of individual pieces 28a and 28b, and also includes an actuator 30. The actuator 30 is mounted to the clamp 15b such that, by actuating the actuator 30, the individual pieces 28a and 28b can be separated or brought together as desired in order to release or secure the third work-piece 20 in the clamp 15b. In accordance with the disclosed example, both spindle assemblies 12 and 14 are oriented along or parallel to an X axis. The actuators 26 and 30 are oriented parallel to a Z axis. Further, in the disclosed example, the axes of each of the individual work-pieces 16, 18 and 20 preferably are oriented along the X axis. One or both of the clamps 15a and 15b may be adjustably mounted to the table 24. In the disclosed example, the clamp 15a is adjustably mounted on a set of rails 32 oriented parallel to the X axis, such that the distance between the clamp 15a and the clamp 15b can be adjusted. The precise location of the individual pieces 25a, 25b and 28a, 28b of the center clamps 15a and 15b can be controlled along the Y and Z axes using suitable shims.

The spindle assembly 12 includes a pair of guide rails 34 which extend to the clamp 15a. A pair of actuators 36a and 36b are mounted to the spindle assembly 12, such that, upon actuating the actuators 36a and 36b, the spindle assembly 12 is movable in a direction parallel to the X axis, such that the spindle assembly 12 can be moved closer to the clamp 15a. Similarly, the spindle assembly 14 includes a pair of guide rails 38 which extend to the clamp 15b. A pair of actuators 40a and 40b are mounted to the spindle assembly 14, such that, upon actuating the actuators 40a and 40b, the spindle assembly 14 is movable in a direction parallel to the X axis, such that the spindle assembly 14 can be moved closer to the clamp 15b. Accordingly, it will be appreciated that during the weld process, the clamps 15a and 15b are held stationary and secure the third work-piece 20, while the rotating spindle assemblies 12 and 14 are movable along the X axis so as to bring the rotating first and second work-pieces 16 and 18 disposed in the spindle assemblies into contact with the third work-piece 20 secured by the clamps 15a and 15b of the center clamp assembly 15.

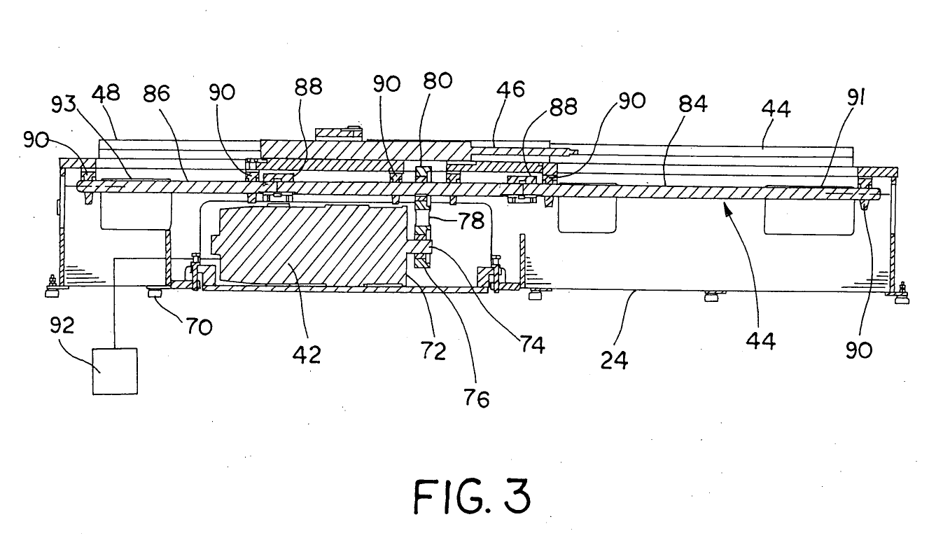

A drive motor 42 (not shown in FIG. 1 but visible in FIG. 3) is mounted to the table 24, and includes a drive train 44 that (also not shown in FIG. 1 but visible in FIG. 3) operatively engages each of the spindle assemblies 12 and 14 in order to transmit rotation of the drive motor 42 to the spindle assemblies 12 and 14 in order to rotate the spindle assemblies. In the disclosed example, the drive train 44 includes a drive belt 46 engaging a pulley 48 on the spindle 12a of the spindle assembly 12, and also includes a drive belt 50 engaging a pulley 52 on the spindle 14a of the spindle assembly 14. Preferably, in order to protect the drive motor 42 and various components of the drive train 44, a rollup cover 54 may be provided at each end of the table 24. The rollup cover 54 is connected to the adjacent spindle assembly 12 or 14 so that the cover 54 pays out from a supply roll in response to movement of the relevant spindle assembly. Similarly, a protective bellows 56 or other suitable cover may be provided between each spindle assembly 12 or 14 and the center clamp assembly 15.

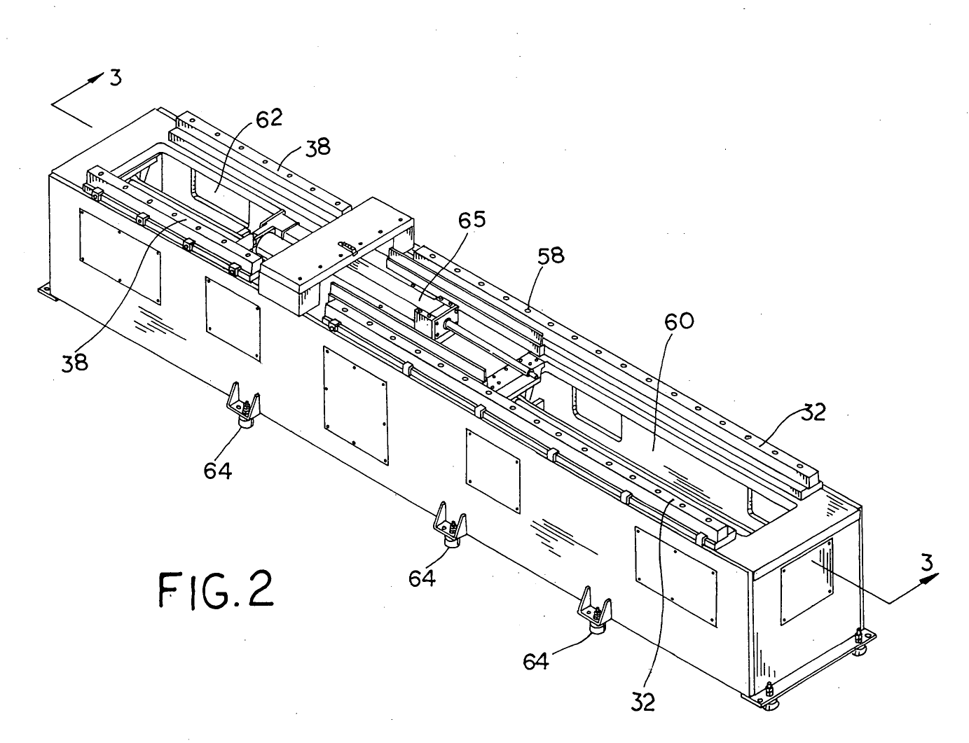

Referring now to FIGS. 2 and 3, the table 24 is shown. A top side 58 of the table 24 includes a pair of openings 60 and 62. The openings 60 and 62 are sized to permit portions of the drive train 44, for example the drive belt 46 and the drive belt 50, to extend upwardly from an interior of the table 24 in order to engage the relevant spindles 12a and 14a. Moreover, the openings 60 and 62 are long enough to permit the movement of the spindle assemblies 12 and 14 along the X axis such that the drive belts 46 and 50 will not encounter any interference. The table 24 may also include adjustable feet 64 to permit leveling of the table 24 on the floor or other support surface. An actuator 65 may be provided in order to move the clamp 15a relative to the clamp 15b along the rails 32.

As shown in FIG. 3, the drive motor 42 is disposed inside the table 24, and operates to simultaneously rotate the spindles 12a and 14a via the drive train 44. Only a portion of the drive train 44 is visible in FIG. 3 (the drive belts 48 and 50, and their associated pulleys, are visible in FIG. 1). The motor 42 includes an output shaft 74, and a drive sprocket 76 or other suitable pulley is mounted to the shaft 74. A drive belt 78 connects the drive sprocket 76 to a second drive sprocket 80. In this example, the first and second drive sprockets 76, 80 have the same diameter, although it is possible to use different diameters in order to change the gear ratio. The drive sprocket 80 engages a drive shaft 82 that is rotatably mounted within the table 24. In the disclosed example, the drive shaft 82 is not a single piece and does not extend the length of the table 24. Instead, the drive shaft 82 includes a right shaft 84 mounted to a right end of the drive shaft 82, and further includes a left shaft 86 mounted to a left end of the drive shaft 82. The right shaft 84 and left shaft 86 are coupled to the drive shaft 82 by suitable coupling assemblies, which are identified by reference numeral 88. Consequently, rotation of the drive shaft 82 rotates both the right shaft 84 and left shaft 86. Preferably, the shafts 82, 84 and 86 are supported by suitable bearings 90 mounted to the table 24. In this example, the right shaft 84 includes a splined right end 91 and the left shaft 86 includes a splined left end 93. Alternatively, the left and right ends 91 and 93 could include gears. As a further alternative, a single-piece drive shaft 82 could be used that the length of the table 24. As used herein, the term drive shaft encompasses both a single drive shaft and a plurality of shafts coupled together.

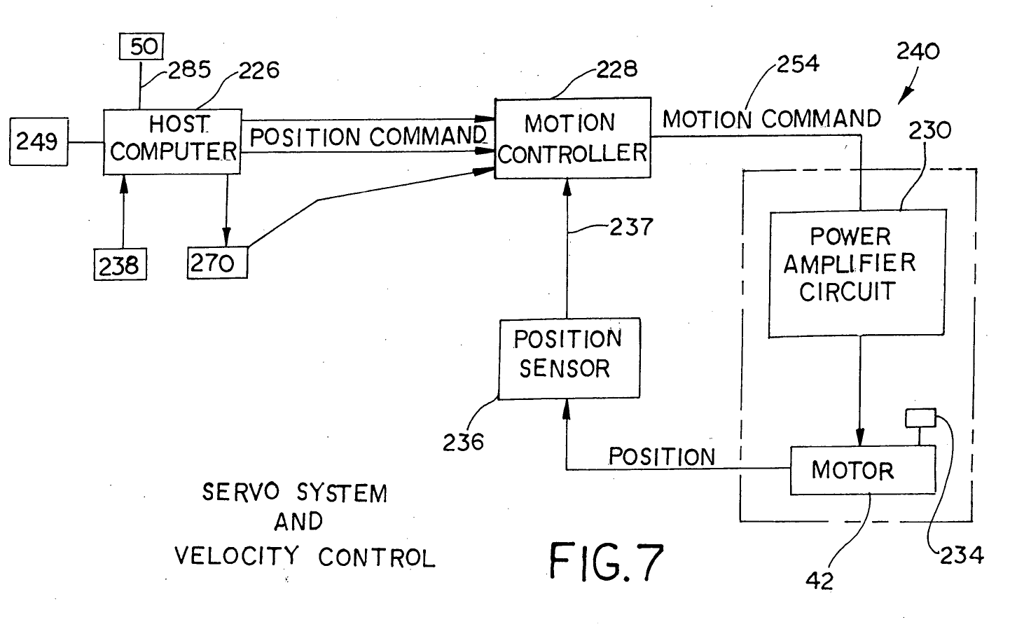

A control system 92 is operatively coupled to the drive motor 42 in order to direct operation of the motor 42, including controlling starting, stopping, the rotational speed, and the angular orientation, during operation of the friction welder 10. The control system 92, using feedback from the motor 42, can read the speed at which the motor 42 is rotating and direct the motor to adjust its speed if necessary. Additionally, the control system 92 may be operatively coupled to the actuators 36a, 36b, 40a, 40b coupled to the spindle assemblies 12, 14, as well as transducers (identified by reference numeral 249 in FIG. 7) for monitoring and controlling the position of the first and second work-pieces 16, 18. The control system 92 can be a personal computer, a PC-compatible industrial computer, a programmable logic controller, a combination of the two, or any other structure that can direct the operation the motor 42 and the actuators 36a, 36b, 40a, 40b.

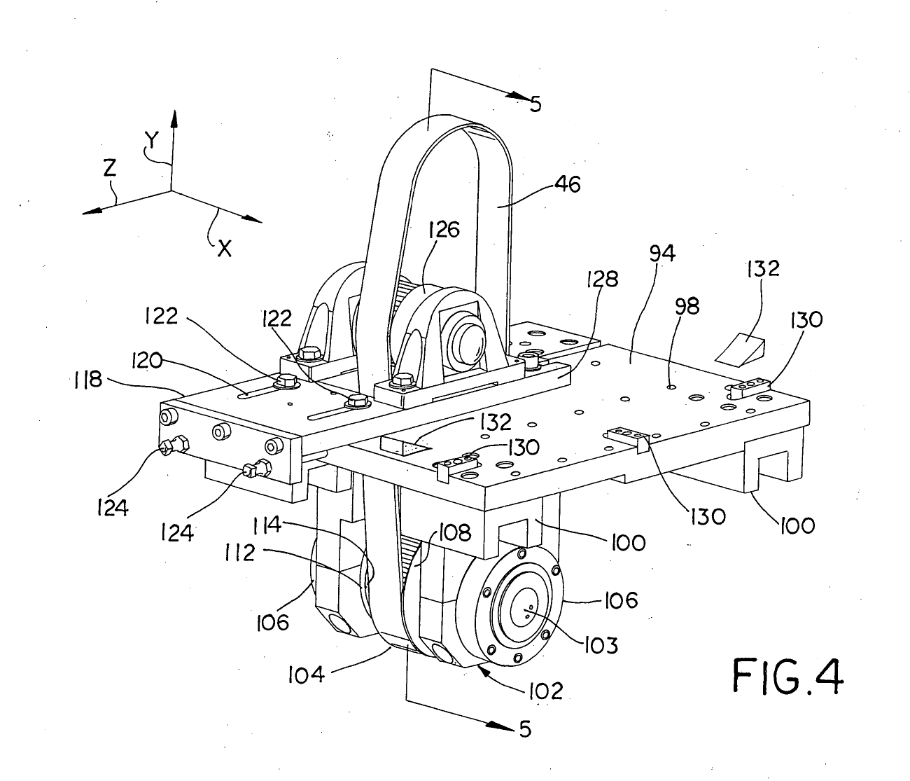

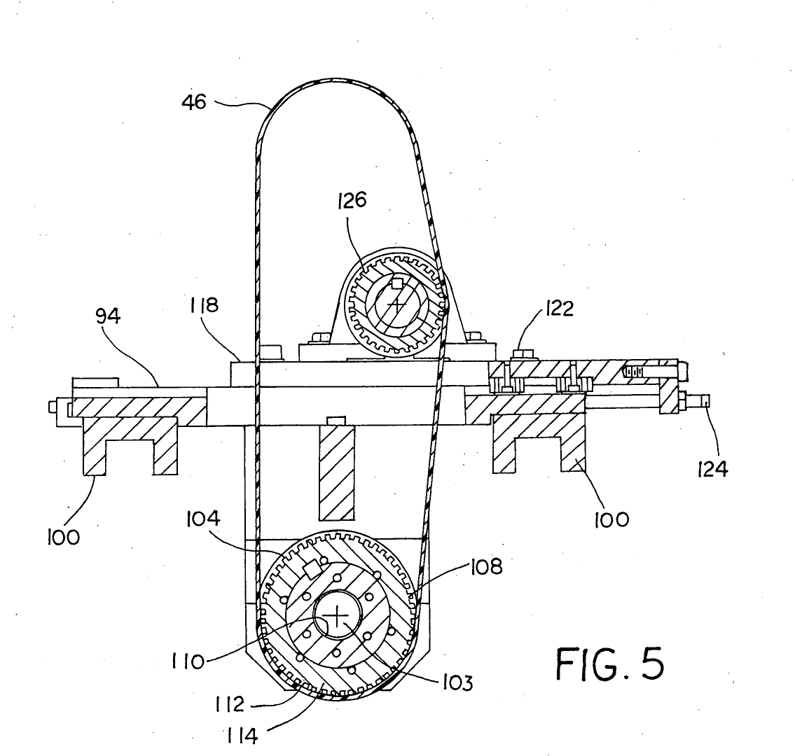

Referring now to FIGS. 4 and 5, a portion of the drive train 44 for driving the spindles 12a and 14a is shown. The portion of the drive train 44 that drives the spindle assembly 12 is shown, although it will be appreciated that the portion of the drive train that drives the spindle assembly 14 may be substantially similar. A slide table 94 includes a pair of guides 100 which are sized and shaped to engage the rails 32 that slidably support the spindle assembly 12. The second spindle assembly 14 also includes a slide table 96 (FIG. 1), which may be substantially similar to the slide table 94 of FIGS. 4 and 5. A gear and bearing assembly 102 is mounted to an underside of the slide table 94. The gear and bearing assembly 102 includes a central aperture 103 that is adapted to engage the splined end 91 of the right shaft 84. The gear and bearing assembly 102, along with the central aperture 103, are arranged so that as the slide table 94 moves along the rails 32, the splined end 91 of the right shaft 84 slides through the central aperture 103. The gear and bearing assembly 102 also includes a lower drive gear or pulley 104 and may also include an idler pulley 126. The drive belt 46 engages both pulleys 104 and 126, and also engages the pulley 48 carried by the spindle 12a. Accordingly, while the drive shaft is rotating, the slide table 94 and hence the entire spindle assembly 12 can slide along the rails 32 without interrupting the operation of the drive train 44 and without interrupting the rotation of the spindle 12a. Suitable bearings are provided, such as bearings 106 that support the pulley 104, and bearings that support the pulley 126. The pulley 104 may include a set of teeth 108 or serrations in order to ensure that rotation of the pulley 104 is transmitted into movement of the drive belt 46. The idler pulley 126 may be mounted to a slide plate 128 to permit adjustment of the tension on the drive belt 46. Suitable slots 120 and fasteners 122 can be provided to permit adjustment, with the slots extending generally parallel to a Z axis (FIG. 1). A pair of locator bolts 124 may be mounted to the slide plate 128, with the locator bolts bearing against a side of the slide plate 94. Rotation of the locator bolts 124 pushes the slide plate 128 in the Z direction, thereby altering the tension on the drive belt 46.

The spindle assembly 12 can be mounted to the slide plate 94 using known fasteners such as bolts and holes 98 in the slide plate 94. A set of locator blocks 130 may be disposed on the slide plate 94 in suitable recesses (not shown). In certain conditions that will be described herein, the location of the spindle assembly 12 relative to the slide plate 94 may require adjustment. Accordingly, shims 132 may be provided, and the shims 132 may be inserted between a lower potion of the spindle assembly 12 and top portion of the slide plate 94. Thus, it will be appreciated that the position of the spindle 12a of the spindle assembly 12 can be adjusted in the Y and Z directions.

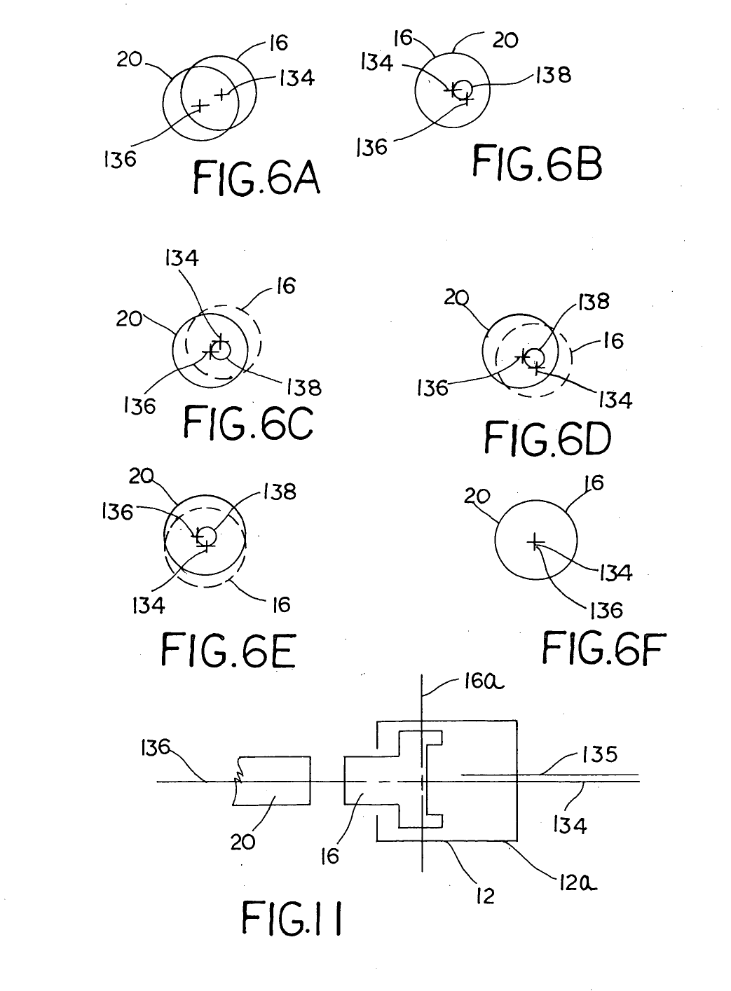

Referring now to FIGS. 6A-6F, the alignment of the first work-piece 16 relative to the third work-piece 20 is shown. It will be understood that, when the first work-piece 16 is disposed in the collett 12b of the spindle 12a, and axis of the first work-piece 16 might not be precisely aligned with the rotational axis of the spindle 12a. This possible misalignment may create a certain amount of runout, which is represented in each of FIGS. 6A-6F by the distance between the axis 134 (the axis of the first work-piece 16) and the axis 136 (the axis of the third work-piece 20). In other words, as shown in FIG. 6A, the axis 134 might not line up with the axis 136, and thus the axes 134 and 136 are not coaxial. The same situation can occur between the second work-piece 18 and the other end of the third work-piece 20. The user can use the shims 132 (described above with respect to FIGS. 4 and 5) to adjust the position of the spindle assembly 12 in the Y and Z directions, which effectively adjusts the position of the axis 134 relative to the position of the axis 136. The user can also perform this shimming process in a similar manner with respect to the second spindle assembly 14.

However, despite adjustments, the axis 134 of the first work-piece 16 may not be precisely aligned with the rotational axis of the spindle 12a for a number of reasons. First, the collet 12b may not secure the first work-piece 16 in a position such that the axis 134 of the first work-piece is coaxial with a rotational axis 135 of the spindle 12a (shown in FIG. 11 and which is the misalignment situation described above), and also may not secure the first work-piece 16 in a position such that the axis 134 of the first work-piece 16 is precisely parallel to the rotational axis 135 of the spindle 12a. Such a situation is illustrated schematically in FIG. 11. Thus, the first work-piece 16 may not revolve around its own axis 134, and may instead rotate in a path 138 outlined in FIG. 6B (this path of rotation is exaggerated for ease of understanding). Thus, as the first work-piece 16 rotates during the weld process, it will follow the path 138 shown in FIGS. 6B-6F. As can be seen, there is only a single angular orientation—or a narrow range of possible angular orientations—in which the axis 134 of the first work-piece 16 is aligned with, or at least most closely aligned with (within an acceptable tolerance), the axis 136 of the third work-piece 20. As is shown in FIGS. 6B through 6F, when the axes 134 and 136 are misaligned, this misalignment can be determined by rotating the spindle 12a and measuring the misalignment using known methods. Using this process, the user can determine which rotational position of the spindle 12a results in the smallest misalignment. This rotational spindle position is then the desired spindle orientation. Further, once the user is able to determine the smallest difference, the user can then adjust the position of the spindle 12a relative to both the Y and Z axes as discussed above. Thereafter, using the control system described herein, it is then possible to complete the weld process with the spindle 12a stopped in the desired spindle orientation. In other words, in order to ensure that the weld process is completed with the least amount of misalignment between the axis 134 of the first work-piece 16 in the axis 136 of the third work-piece 20, the control system 92 must be used so that rotation of the first work-piece 16 stops at the desired spindle orientation when the weld process is finished.

Both spindles 12a and 14a rotate at the same time and in the same direction by virtue of their connection to the drive shaft 82 of the drivetrain 44. Further, both spindle assemblies 12 and 14 can be adjusted relative to the Y and Z axes independently. Consequently, as long as the first and second work-pieces 16 and 18 have the proper starting orientation relative to one another, then the first and second work-pieces 16 and 18 will have the same ending orientation relative to one another, by virtue of the fact that both spindles 12a and 14a are driven by the same drivetrain 44. Moreover, by controlling the angular orientation of the spindles 12a and 14a at the end of the weld process, both spindles 12a and 14a will stop at the desired spindle orientation.

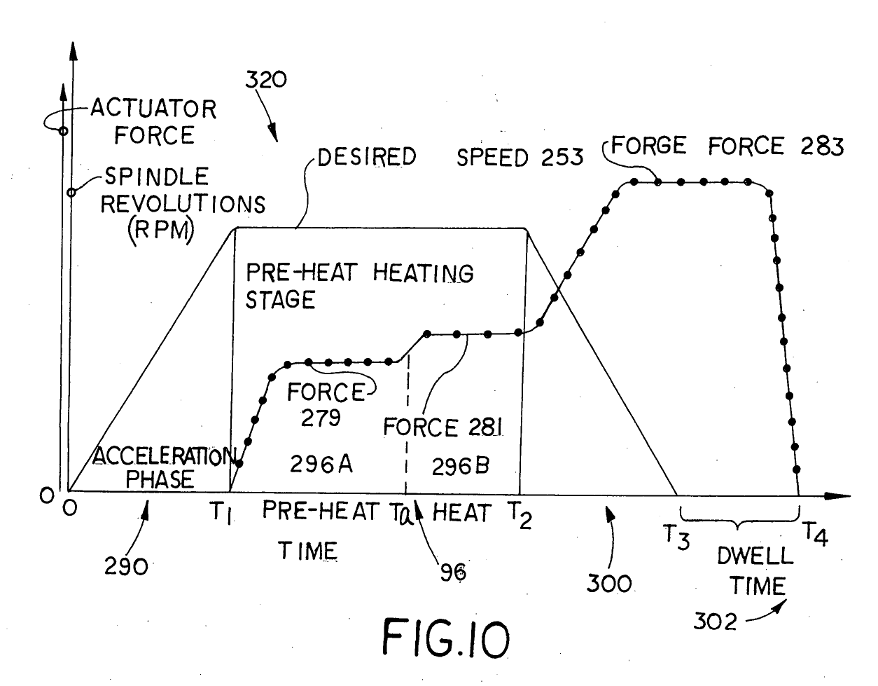

As shown in FIG. 7, the control system 92 includes a computer 226 or PLC (or both) which is operatively connected to a motion controller 228 and at least one transducer 249. In one embodiment, the at least one transducer 249 includes a pair of transducers that may include, for example, position sensors adapted to detect the position of the spindle assemblies 12, 14. The transducers 249 therefore in one embodiment would be disposed on the table 24 or directly on the spindle assemblies 12, 14. The motion controller 228 is operatively connected to a power amplifier 230, the drive motor 42 which includes a tachometer 234, and position sensor 236. The motion controller 228, power amplifier 230, drive motor 42, tachometer 234, and position sensor 236 together form a control loop 240. The drive motor 42 is preferably a variable speed drive motor commonly employed in the art, and the tachometer 234 and position sensor 236 are likewise commonly employed in the art. Preferably, the position sensor 236 is calibrated to measure the angular position of the output shaft 74 as it rotates about its axis in increments of a rotation, and position sensor 236 converts the detected position to an actual position command 237. The position sensor 236 also tracks the actual number of rotations during each of the weld phases, such as the actual acceleration, pre-heat, heat and forge rotations, respectively, as discussed below. Preferably, each complete rotation of the output shaft 74 can be broken into a thousand discrete angular positions. Based on a number of material variables input by the operator, such as the material weight, dimensions, and thickness of first, second and third parts, the host computer 226 generates a desired spindle profile (shown in FIG. 10) which represents the desired rotational speed of the output shaft 74 at any moment during the weld cycle. The desired final angular position of the first work-piece 16 and second work-piece 18 relative to the third work-piece 20 is input into the computer 226 via an input register 238 and is communicated to motion controller 228. The operator inputs the material variables mentioned above into the host computer 226, which then calculates the desired total number of spindle rotations required between the actual starting position and the desired final position. The total number of desired rotations includes the desired acceleration rotations, the desired pre-heat rotations, the desired heat rotations, and the desired forge rotations.

The tachometer 234 generates a signal which indicates the actual speed (see FIG. 9) of the drive motor 42, while the position sensor 236 (see FIG. 7) generates a signal which indicates the actual angular position of the output shaft 74. Based on the desired final position and the actual position, the motion controller 228 generates a motion command 254 or speed signal which is communicated to the power amplifier circuit 230 and then to drive motor 42. Thus, a control loop 240 is formed which continuously generates feedback regarding the actual speed and the actual position of the output shaft 74, which matches the actual speed and position of the first work-piece 16. Ideally, actual speed closely approximates desired speed, while actual position closely approximates the desired position. The desired position, which is generated by the host computer 226 as explained below, represents the desired angular position of the output shaft 74 relative to its axis of rotation at any particular point in time during the weld cycle. Any differences between actual speed and/or position and desired speed and/or position are corrected by the control loop 240 as discussed in greater detail below.

Referring now to FIG. 9, the amplifier circuit 230 includes summation node or junction 258 which sums the difference between the speed signal 254 and the actual speed 235. The junction 258 generates a difference signal 259, which is communicated to velocity amplifier 260, which in turn generates a current command signal 262. Current command signal 262 is communicated to summation node or junction 264, which sums the difference between current command signal 262 and current feedback signal 266 from motor 42. Junction 264 generates a difference signal 265, which is communicated to amplifier 268, which is connected to the drive motor 42.

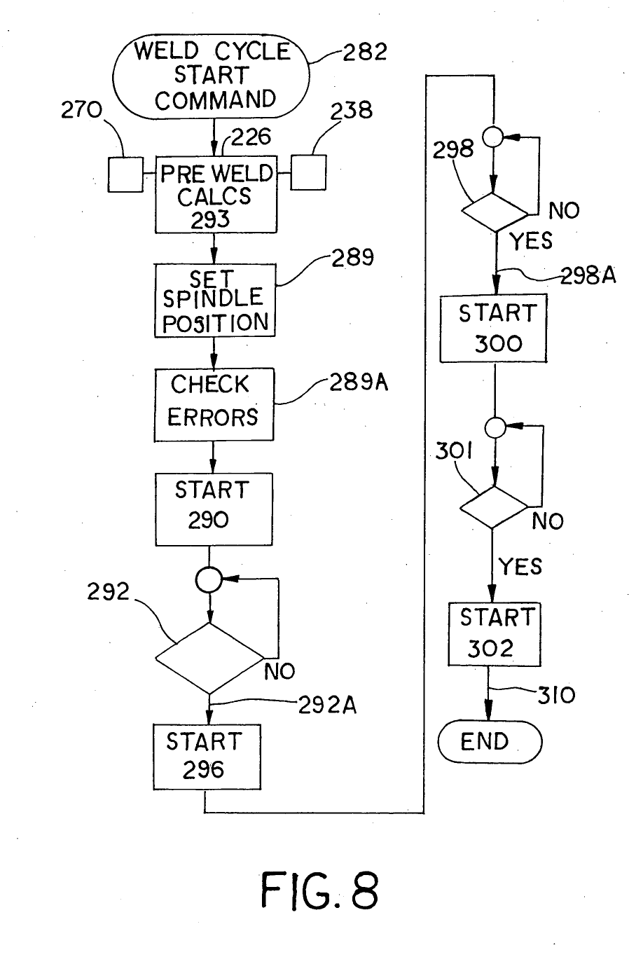

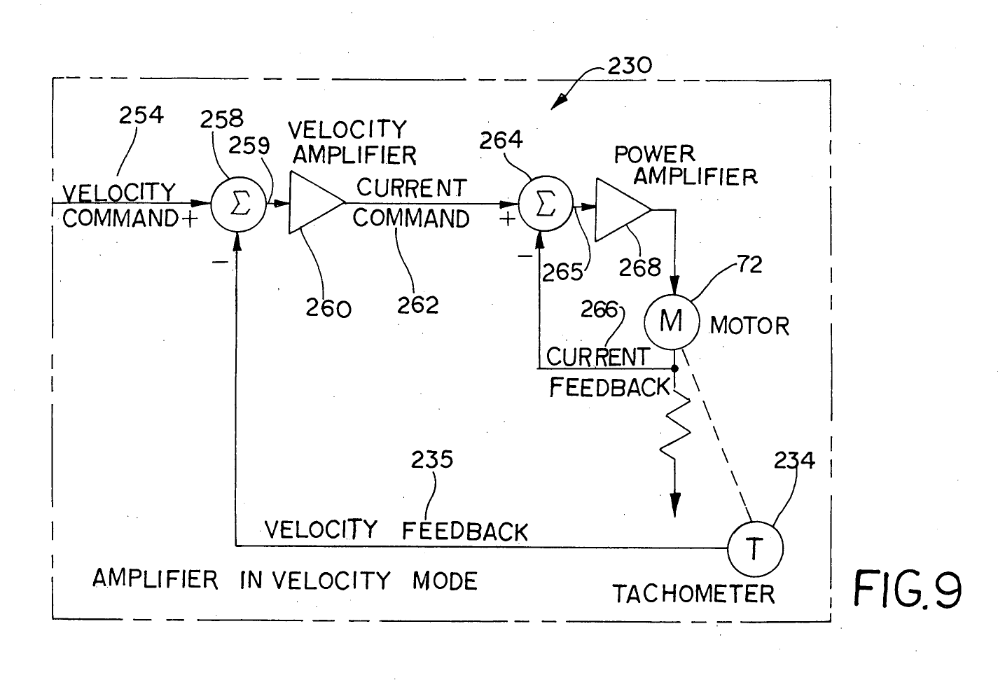

FIG. 8 shows a flow chart of the weld cycle employing orientation control in accordance with the friction welder 10 disclosed herein. Upon commencement or start 282 of the weld cycle, the computer 226 performs a series of pre-weld calculations 293 stored in output register 270. The values for each of the output variables depend on a number of variables programmed into the input register 238. The input variables include, for example, the type of material to be welded, the weight of the rotating work-piece, and the geometric or size properties of the work-pieces to be welded together. The input register 238 also includes the desired final angular orientation between the work-pieces relative to their common axis, the lengths of the first and second work-pieces 18, 20, respectively, the length of the third work-piece 20, and the desired length for the finished product. The computer 226 obtains values based on input values and performs calculations to determine the parameters of the weld process, including the number of forge rotations required for the spindle to stop at the desired angular position at the calculated forge force level.

When the operator initiates the start command 282, the computer 226 generates the spindle profile curve 320 shown in FIG. 10, and also sets the start position of slide table 94 so that the total travel of the slide table 94 will match the desired upset distance. Before the spindle rotation begins, a subroutine 289 causes the motion controller 228 to designate the position of the output shaft 74 a setpoint or “home” mark and communicates a go command to the motion controller 228, which in turn communicates the speed signal 254 to the drive motor 42, and absent any positional errors detected by subroutine 289A, commencing the rotation of the output shaft 74.

As shown in FIG. 10, the first phase of the weld cycle is the acceleration phase 290, during which the output shaft 42 is accelerated to a desired rotational speed 253. During acceleration phase 290, subroutine 292 (see FIG. 8) via control loop 240 constantly compares the actual spindle acceleration rotations, in increments of 1/4000th of a revolution, to the desired spindle acceleration rotations as dictated by the spindle profile 320 for that particular moment during the acceleration phase 290. While the increments have just been described as including 1/4000th of a revolution, alternative embodiments may include any rotational increments including, for example, 1/1000th, 1/10,000th, or any other increment capable of serving the principles of the present disclosure. The motion controller 228 makes the necessary speed adjustments via speed signal 254 as required, and the comparison by subroutine 292 continues until the acceleration phase 290 is complete. Subroutine 292 typically triggers the completion of the acceleration phase by monitoring the total spindle rotations for that phase, but may also be programmed to trigger the end of the first phase 290 based on elapsed time.

Upon completion of another subroutine 292A checking for errors and any necessary in-process corrections, a signal is sent to computer 226 which indicates that the second phase 296 is about to commence. Phase 296, which commences at a time indicated by time T1 in FIG. 10, includes both a pre-heat phase 296A and a heating phase 296B. Phase 296B terminates when the material at the interface between the first work-piece 16 and the third work-piece 20 has reached a plastic state, which should coincide with the completion of the desired pre-heat rotations and the desired heating rotations, and which signals the end of phase 296. At the beginning of phase 296, the output shaft 74 is rotating the spindles 56 at the desired rotation or weld speed, and the motion controller 228 via control loop 240 maintains the rotation the output shaft 74 at this desired speed. During the pre-heat stage 296A, the computer 226 sends a force command 285 to the actuators 36a, 36b, which moves the spindle assembly 12 and brings the first work-piece 16 into contact with the third work-piece 20. Generally, simultaneously, the actuators 40a, 40b move the spindle assembly 14 and bring the second work-piece 18 into contact with the third work-piece 20. The first and second work-pieces 16, 18 are brought into contact with the third work-piece 20 at the pre-heat pressure force level 279. Subsequently, at stage 296B the actuators 36a, 36b, 40a, 40b cause the first and second parts 18, 20 to be continuously forced against the third work-piece 20 at a specific heat pressure force level 284. The fiction between the first and second work-pieces 18, 20 against the third work-piece 20 immediately begins to heat the interface between the parts at the commencement of stage 296A, and the heating continues through stage 296B. During phase 296, subroutine 298 via control loop 240 constantly compares the actual pre-heat rotations, in increments of 1/4000th of a revolution, to the desired pre-heat rotations, plus the desired number heating rotations to the actual heating rotations as dictated by the spindle profile 320 for that particular moment during phase 296. When subroutine 298 detects that the total heating rotations have been completed with the material at the work-piece interface reaching a plastic state, subroutine 298 indicates the completion of phase 296 by sending a signal to computer 226.

Phase 296 is followed by a forge phase 300 which commences at time T2, and which terminates when the desired forge rotations have been completed and the spindle rotation has stopped, which occurs at time T3. During forge phase 300, the output shaft 74 decelerates in accordance with profile curve 320. Forge phase 300 is in turn followed by a dwell phase 302 in which the three parts 18, 20, 22 are maintained under pressure as the material at the interfaces cools, with phase 302 terminating at time T4. At the initiation of the forge phase 300, motion controller 228 begins decelerating the output shah 74, and subroutine 301 via control loop 240 constantly compares the desired forge rotations, in increments of 1/4000th of a revolution, to the actual forge rotations as dictated by the spindle profile 320 for that particular moment during phase 300, and motion controller 228 makes the necessary speed adjustments via speed signal 254. The comparison by subroutine 301 continues until the forge phase 300 is complete at time T3, at which point the output shaft 74 has stopped and the spindles 12a, 14a are at the desired final position. Also during the forge phase 300, as the output shaft 74 begins to slow down, computer 226 sends a signal to the actuators 36a, 36b, 40a, 40b, which causes an increase in pressure between first work-piece 16 and third work-piece 20, and between the second work-piece 18 and the third work-piece 20, up to the forge force level 283.

When output shaft 74 stops, computer 226 measures the actual travel of the actuators 36a, 36b, 40a, 40b and compares the actual upset length to the desired upset length and determines if the actual upset is within bounds. Subroutine 310 monitors the time under forge pressure, and sends a signal to computer 226 when the dwell time is complete, which occurs at time T4. At time T4, the forge pressure is released and the weld cycle is complete. Finally, motion controller 228 reports any final positional errors to computer 26, which can be communicated to the operator. Once again, the orientation may be controlled using an orientation system of the type found in commonly assigned U.S. Pat. No. 5,858,142, the entire disclosure of which is incorporated by reference herein.

In this example a single drive shaft extends the length of the table and drives both the spindle 12a and the spindle 14a using a single drive motor. It has been found that such a design is robust and can accurately drive both spindles 12a, 14a relative to each other and also produce the driving force necessary to produce the weld. This has proved especially useful in materials difficult to friction weld such as aluminum. By using a single shaft to drive both spindles, the relationship between the first spindle 12a and the second spindle 14a is directly controlled.

In use of the friction welder 10, a user inserts the first work-piece 16 into the spindle assembly 12 and inserts the second work-piece 18 in the second spindle assembly 14. In this particular example, the first and second parts 18, 20 are yokes for a drive shaft. As is known, yokes are required to be angularly disposed 90° from each other along the drive shaft. Thus, a user will place the second work-piece 18 in the second spindle assembly 14 such that this orientation is achieved. Because the spindles 12a and 14a of the first and second spindle assemblies 12 and 14 are operatively coupled through the drive train 44, any rotation of either of the spindles 12a and 14a will result in an equal rotation of the other spindle. Thus, this relative angular orientation between the first work-piece 16 and the second work-piece 18 is maintained throughout the welding process.

The third work-piece 20 is placed in the center clamp assembly 15. To ensure that a quality weld is achieved, the first work-piece 16 is aligned with the third work-piece 20 by shimming the spindle assembly 12 as outlined above, so that the axis 134 of the first work-piece 16 is aligned with the axis 136 of the third work-piece 20. This process is repeated with the second work-piece 18 so as to align the axis of them second work-piece 18 with the axis 136 of the third work-piece 20. However, because the first work-piece 16 and/or the second work-piece 18 might not be perfectly aligned with the third work-piece 20 and at least some spindle orientations, the axis 134 of the first work-piece 16 may not remain aligned with the axis 136 of the third work-piece 20 at all spindle orientations while the first work-piece rotates 16 in the spindle assembly 12. However, because the desired spindle orientation has been determined as outlined above, as long as the spindle is stopped at the desired spindle orientation the axes 134 and 136 of the first work-piece 16 and the third work-piece 20 will be properly aligned (within an appropriate tolerance). The same holds true for the alignment of the second work-piece 18 and the third work-piece 20. During the welding process, the control system 92 constantly monitors the rotational position of the spindles to ensure that the spindles stop in the desired spindle orientation.

Referring now to FIG. 11 the spindle 12a of the spindle assembly 12 includes the rotational axis 135. As is shown, the axis 134 of the first work-piece 16 might not be positioned in precise alignment with the axis 135 of spindle 12a. This misalignment may be one cause of the runout illustrated in FIGS. 6A-6F. However, by rotating the spindle 12a through a number of possible positions, such as, for example, four positions located in four rotational quadrants, the user may determine which rotational position results in the smallest misalignment, and may easily determine whether that smallest misalignment falls within acceptable tolerance. The size of the acceptable tolerance will vary in accordance with the end application of the welded work-pieces, and determining the exact size of the tolerance for the end application is a design consideration and may be determined by those of skill in the art. The rotational position of the spindle 12a that results in the smallest misalignment may be the desired spindle position, and may be both the starting point in the finishing point for the spindle during the weld process.

In another example, a first motor drives the first spindle assembly and a second motor drives the second spindle assembly. Both the first motor and the second motor are controlled by a controller to ensure that the first and second spindles are being controlled relative to each other. In such a set up the controller can control the individual motors independently. As such, if the first work-piece 16 and the second work-piece 18 have different material properties, they may require a different weld process, i.e., higher forge force, faster revolutions, or the like. The controller can ensure that the final positions of the first part and the second part are the desired positions.

As mentioned above, the controller 226, in one embodiment, may be operatively coupled to the spindle assemblies 12, 14, as well as a pair of transducers 249. In the weld process described herein, the computer 226 measures the actual travel of the actuators 36a, 36b, 40a, 40b and compares the upset length to a desired upset length ad determines if the actual upset length is within acceptable bounds or tolerances. More specifically, the computer 226 may be in substantially continuous communication with the transducers 249 to substantially continuously monitor the position of the spindle assemblies 12, 14. So configured, the friction welder 10 disclosed herein may be used to accurately and consistently control the final length of the final product, which includes a drive shaft 22 in the example disclosed hereinabove.

In performing length control, the computer 226 may use the lengths of the first, second and third work-pieces 16, 18, 20, as well as the final desired length of the drive shaft 22. In standard operations, the desired final length will be known and input into the input register 238 by the operator. Additionally, the lengths of each of the first, second and third work-pieces 16, 18, 20 may independently be known, for example, through a pre-measuring process. In such a case, these values may also be entered into the input register 238 by the operator. However, the friction welder 10 could also perform a calibration process prior to beginning the weld process described above.

Such a calibration process would be conducted subsequent to the operator inserting the work-pieces 16, 18, 20 into the friction welder 10, but prior to beginning the weld process. With the work-pieces 16, 18, 20 secured into their respective spindles 12a, 14a and clamp assembly 15, the operator would instruct the computer 226 to perform calibration. First, the computer 226 would instruct the actuators 36a, 36b, 40a, 40b to begin driving the first and second work-pieces 16, 18 toward the third work-piece 20. During this period, the computer 226 constantly monitors the transducers 249 and therefore the position of the spindle assemblies 12, 14. In one embodiment, for example, the computer 226 may take a positional reading from the transducers 249 every 1/1000th of a second. It should be appreciated, however, that these readings could be taken at nearly any frequency capable of serving the principles of the disclosure. From these readings, the computer 226 can calculate and monitor the rates at which each of the first and second work-pieces 16, 18 are traveling toward the third work-piece 20. Once the first and second work-pieces 16, 18 abut the third work-piece 20, their travel rates will drop to zero and the computer will instruct the actuators 36a, 36b, 40a, 40b to cease operation. At this point, the computer 226 takes a reading from the transducers 249. This reading identifies the precise location of each of the spindle assemblies 12, 14 and enables the computer 226 to calculate an initial overall length of the combined work-pieces 16, 18, 20. The computer 226 stores each of these values.

Based on this initial overall length, the computer 226 would determine if the combined work-pieces 16, 18, 20 are sufficiently dimensioned to produce a final work-piece 22 having a final desired length within predetermined tolerances. For example, the initial overall length may be too short or too long to undergo an effective or desirable friction weld process. In conducting this determination, the computer 226 considers the initial overall length, the desired final length, and an average amount of length loss, for example, during the weld process. The computer 226 subtracts the average amount of length loss from the initial overall length to define a maximum final length. The computer 226 compares this maximum final length with the desired final length. If the computer 226 determines that the maximum final length is less than the desired final length within predetermined tolerances, the computer 226 issues a notification to the operator that the final product may not meet the dimensional specifications, thereby allowing the operator to substitute one or more of the work-pieces 16, 18, 20 with a different work-piece that would allow the tolerances to be met. In an alternative form, the computer 226 may even notify the operator of which of the three work pieces 16, 18, 20 needs replacement. In another form, the machine 10 may be automated and, therefore, may automatically replace one or more of the work pieces 16, 18, 20 without notifying the operator at all. However, if the maximum desired length is greater than or equal to the desired final length within predetermined tolerances, the computer 226 instructs the actuators 36a, 36b, 40a, 40b to back the first and second work-pieces 16, 18 away from the third work-piece 20 and begin the weld process.

As mentioned above, in some circumstances, the maximum final length may be much greater than the final desired length, thereby defining a combination of work-pieces 16, 18, 20 too long to undergo an effective or desirable weld process. This may be because the welding process or quality of the weld may be compromised if too much material must be removed. In this situation, the computer 226 may alert the operator or automatically substitute one or more of the work-pieces 16, 18, 20.

After completing the calibration process, the computer 226 would then perform the weld process, as described above, with the additional feature of monitoring the length of the product. Specifically, during the friction weld process, the computer 226 continuously monitors the positions of the spindle assemblies 12, 14 via the transducers 249. The computer 226 also continuously compares the current position of the spindle assemblies 12, 14 to the stored position of the spindle assemblies 12, 14 that was detected during the calibration process and associated with the initial overall length of the combined work pieces 16, 18, 20. Therefore, while the interfaces between the first and third work-pieces 16, 20 and the second and third work-pieces 18, 20 reach a plastic state during the heating phase 296B of the friction weld process described above with reference to FIG. 10, the computer 226 can closely monitor the change in length of the combined work-pieces 16, 18, 20 and adjust the process accordingly. For example, although the interfaces between the various work-pieces may be sufficiently plasticized to accommodate the transition from the heating phase 296B to the forge phase 300, as identified in FIG. 10 and describe above, if the computer 226 determines that the overall length of the product is not within the predetermined tolerances, the computer 226 may prolong the heating phase 296B by continuing to instruct the actuators 36a, 36b, 40a, 40b to force the first and second work-pieces 16, 18 into the third work-piece 20. This will further dispose of material at the interfaces and decrease the final overall length of the drive shaft 22. Through continued monitoring of the transducers 249, the computer 226 can then determine when the overall length falls within the predetermined tolerances. Upon this occurring, the computer 226 can control the friction welder 10 to transition to the forge phase 300 and complete the weld.

While the length of the final product has been described as being controlled by adjusting the time that the actuators 36a, 36b, 40a, 40b apply force to the first and second work-pieces 16, 18, the computer 226 may control the final length by adjusting other parameters such as the amount of pressure or force applied by the actuators 36a, 36b, 40a, 40b, the rotational velocity of the first and second spindles 12a, 14a and, therefore, the first and second work-pieces 16, 18, or any other parameter associated with the machine 10 and capable of serving the disclosed purpose,

Further yet, while the length-control process has been described as being based primarily on the continuous monitoring of the positions of the spindle assemblies 12, 14, in an alternate form, the computer 226 may perform a pre-weld calculation to determine a weld process control algorithm for producing a final product meeting the desired final length within predetermined tolerances. This pre-weld calculation may be based on the initial overall length of the work-pieces, historical weld data, weld parameter calculations, or other information associated with the material, the final product, or the machine being used. Historical weld data may include, for example, average material loss, average beat generation, average weld strength, average time ranges for completing the welds, or any other useful information that may be recorded and stored for subsequent use. The weld parameter calculations may include calculations approximating velocity profiles, force profiles and time ranges, for example, based on the particular properties of the material used, the sizes of the work-pieces 16, 18, 20 or any other information.

In a further alternative situation, during the weld process, a material defect in one or more of the work pieces 16, 18, 20 may cause the overall length of the work-pieces to rapidly and unexpectedly deteriorate. The computer 226, through continuous monitoring of the transducers 249, can identify this and adjust the weld process accordingly. For example, the computer 226 may adjust the rotational velocity of the first and second work-pieces 16, 18 or the movement of the spindle assemblies 12, 14 in an effort to reach the final desired length.

As stated above, if the computer 226 determines during the calibration process that the initial overall length of the work-pieces 16, 18, 20 is insufficient to undergo the friction weld process and meet the desired final length, the computer 226 may notify the operator to enable the operator to substitute one or more of the work-pieces 16, 18, 20 for different work-pieces. Alternatively, however, in some circumstances, the operator may determine to continue with the weld process although the computer 226 indicates that the initial overall length may be insufficient. In this case, the computer 226 would instruct the friction welder 10 to proceed with the weld process. During the weld process, however, the computer 226 may still continuously monitor the positions of the spindle assemblies 12, 14. During this continuous monitoring, the computer 226 may determine that by an adjustment of the weld process, the final desired length may be achieved. For example, if the computer 226 determines that the overall work-piece length is approaching the final desired length, the computer 226 may increase the rotational velocity of the first and second work-pieces 16, 18 to more quickly transition between the heating phase 296B and the forge phase 300. This determination by the computer 226 may be dependent on the type of material being friction welded, the geometry and/or the size and weight. Nevertheless, the computer 226 actively pursues a product having a desired final length within predetermined tolerances.

Accordingly, it should be appreciated that while this length control process has been described as being implemented in conjunction with the orientation control process described above, the friction welder 10 disclosed herein may perform the length control process independently of the orientation control process. Furthermore, it should be appreciated that the friction welder 10 disclosed herein may be utilized to accurately and consistently orient the axes of multiple components, as well as accurately and consistently control the length of multi-component products such as the drive shaft 22 described hereinabove.

The foregoing description is not intended to limit the scope of the invention to the precise form disclosed. It is contemplated that various changes and modifications may be made by those skilled in the art without departing from the spirit and scope of the invention.

We claim:

1. A friction welding system, comprising:
a first spindle rotatable about a first axis and arranged to secure a first work-piece;
a second spindle rotatable about a second axis and arranged to secure a second work-piece;
a clamp disposed between the first and second spindles and arranged to secure a third work-piece;
a motor operatively coupled to the first and second spindles and arranged to simultaneously rotate the first and second spindles in the same direction: and
a controller operatively coupled to the motor and arranged to control a speed and an angular orientation of the motor thereby simultaneously controlling a speed and an angular orientation of the first spindle and the second spindle, the angular orientation including a desired ending spindle position;
a first actuator arranged to move the first spindle and the clamp toward one another thereby enabling the first work-piece to meet the third work-piece at a first interface; and
a second actuator arranged to move the second spindle and the clamp toward one another thereby enabling the second work-piece to meet the third work-piece at a second interface.

2. The system of claim 1, wherein the first spindle and the second spindle are adjustable relative to a Y axis and a Z axis that is substantially perpendicular to the Y axis.

3. The system of claim 2, wherein the first and second actuators are positioned to move the first and second spindles in a direction parallel to an X axis that is substantially perpendicular to the Y axis and the Z axis.

4. The system of claim 1, wherein the drive motor is operatively coupled to a driveshaft, and wherein the first spindle and the second spindle are operatively coupled to the driveshaft.

5. The system of claim 4, wherein the driveshaft is a multiple-piece driveshaft.

6. The system of claim 4, wherein the driveshaft includes at least one splined portion.

7. The system of claim 1, wherein the first spindle and the second spindle are each operatively coupled to the drive motor by a drive belt.

8. The system of claim 1, wherein the drive motor is operatively coupled to the first spindle and the second spindle so as to rotate the first spindle and the second spindle in the same direction.

9. The system of claim 1, wherein the first and second spindles are positionable in a beginning spindle position, and wherein the beginning spindle position is substantially the same as the ending spindle position.

10. The system of claim 1, further comprising at least one transducer operatively coupled to the controller for enabling the controller to detect a position of the first and second spindles.

11. A friction welding system, comprising:
a first rotatable spindle arranged to secure a first work-piece, the first spindle movable along an X axis and adjustable relative to a Y axis that is substantially perpendicular to the X axis and a Z axis that is substantially perpendicular to the X axis and the Y axis;
a second rotatable spindle arranged to secure a second work-piece, the second spindle movable along the X axis and adjustable relative to the Y axis and the Z axis;
a clamp assembly arranged to secure a third work-piece, the clamp assembly adjustable relative to a Y axis and a Z axis;
a motor operatively coupled to the first and second spindles by a drivetrain comprising a single driveshaft; and
a controller operatively coupled to the motor for controlling the motor and arranged to control the rotational position of the motor.

12. The system of claim 11, wherein the controller is arranged to recognize a desired beginning spindle position and a desired ending spindle position.

13. The system of claim 11, further comprising at least one transducer operative coupled to the controller and at least one of the first spindle and the second spindle, the controller arranged to control the position of the at least one first spindle and the second spindle along the X axis.

14. The system of claim 11, wherein the controller controls the position of the at least one first spindle and the second spindle based on information obtained from the at least one transducer.

15. A method of orienting a first work-piece and a second work-piece relative to a third work-piece in a friction welding machine, the method comprising:
placing the first work-piece in a first spindle assembly including a first spindle;
placing the second work-piece in a second spindle assembly including a second spindle;
placing a third work-piece in a clamp assembly disposed between the first and second spindle assemblies;
adjusting the position of the third work-piece relative to a Y axis and a Z axis that is substantially perpendicular to the Y axis;
adjusting the position of the first and second work-pieces relative to the Y axis and the Z axis;
rotating the first and second spindles to determine a desired spindle position for the first and second spindle assemblies, the desired spindle position placing a longitudinal axis of the first work-piece and the second work-piece in alignment with a longitudinal axis of the third work-piece within an acceptable tolerance;
orienting a transverse axis of the first work-piece relative to a transverse axis of the second work-piece;
rotating the first spindle at a speed to create a friction weld between the first and third work-piece;
rotating the second spindle at a speed to create a friction weld between the second work-piece and the third work-piece;
stopping the rotation of the first and second spindles at the desired spindle position.

16. A method of controlling a length of a work-piece in a friction welding machine, the method comprising:
placing a first work-piece in a first spindle assembly including a first spindle;
placing a second work-piece in a second spindle assembly including a second spindle;
placing a third work-piece in a clamp assembly disposed between the first spindle assembly and the second spindle assembly;
rotating the first spindle to create a plasticized state between the first work-piece and the third work-piece;
rotating the second spindle to create a plasticized state between the second work-piece and the third work-piece;
monitoring the combined length of the first work-piece, the second work-piece, and the third work-piece while rotating the first spindle and the second spindle;
stopping the rotation of the first and second spindles when the combined length is equal to a final desired length within predetermined tolerances.

17. The method of claim 15, wherein monitoring the combined length includes detecting a position of the first and second spindles.
